(19) United States
(12) Patent Application Publication
(10) Pub. No.: US 2014/0192029 A1
(43) Pub. Date: Jul. 10, 2014

(54) TOUCH PEN FOR PORTABLE TERMINAL HAVING GENDER UNIT

(71) Applicant: GT TELECOM CO., LTD, Gumi-shi (KR)

(72) Inventor: Joo Won Heo, Gumi-shi (KR)

(73) Assignee: GT Telecom Co., Ltd, Gumi-shi (KR)

(21) Appl. No.: 13/736,518

(22) Filed: Jan. 8, 2013

(51) Int. Cl. G06F 3/0354

(52) U.S. Cl. CPC G06F 3/03545
USPC 345/179

(57) ABSTRACT

A touch pen includes a hollow pen body (110), a connector cap (150), of which one end is coupled to an end of the pen body (110), a cover cap (114) coupled to the other end of the connector cap (150), and a gender unit (130) including a first connector (131) at one end and a second connector (132) at the other end. The first connector (131) protrudes to the cover cap (114) side, and is fixedly accommodated by being embedded in the connector cap (150). The second connector (132) is connected to a flexible cable (133) extending from the connector cap (150) and accommodated in the pen body (110). In addition, the first connector (131) of the gender unit (130) forms a standard USB, and the second connector (132) connected with the flexible cable (133) at the other end of the gender unit (130) forms a micro USB.

### BACKGROUND OF THE INVENTION

1. Field of the Invention

The present invention relates to a touch pen for a portable phone having a gender unit, and more particularly to a touch pen for a portable terminal configured in such a manner that the touch pen used as a stylus pen for operating a touch screen of a portable terminal, such as a smart phone, is provided with a gender unit for use in interconnecting an external cable or an external device with the portable terminal, thereby providing convenience in use.

2. Description of the Prior Art

In general, the term, portable terminal, is used to refer to a portable electronic device, such as a portable phone, a portable computer, a PDA, an electronic scheduler, a digital camera, an MP3 player, or a PMP. The use of such portable terminals has been gradually increased, and is now popularized to such an extent that the portable terminals become necessities of life. Recently, due to rapid supply of smart phones, the screens of the portable terminals are becoming larger and larger in order to increase the utilization of the portable terminals.

Referring to a portable phone, which is represented by a smart phone which is most universally used among these portable terminals, an internal circuit is configured for an interface for communication between the portable phone and the outside in which the internal circuit may be varied according to the maker and type of the portable phone. In addition, a plurality of connectors are formed on a side of a case of the portable phone to interconnect the internal circuit and the external interface, thereby enabling an interfacing with the outside by inserting an external communication cable or a charge cable into to any of the connectors to be connected therewith.

In general, a gender for a portable terminal is a connector that has a pin structure in order to allow a pin connector of a terminal, such as a smart phone, to be mated with a USB connector popularized for interconnection between different types of devices or for electric charging to a personal computer or the like, thereby serving as a connection medium that allows a charger to be used or to be connected to a USB. Typically, the gender may be classified as an accessory for use in charging a portable phone and data transmission.

Recently, due to the progress of semiconductor terminologies and electronic terminologies, the supply of smart phones with a touch panel to which a touch screen type is adopted is expanded. Such a touch panel is configured in such manner that an operator can operate a system of the portable terminal by touching a transparent plate provided on the top of the touch screen (display screen) using fingers or a touch pen.

Such a touch panel is classified into a resistive type, a capacitive type, an infrared type, and an ultrasonic type. Recently used the most is a capacitive coupling type touch panel which is configured such that when a user (human) touches the touch screen, an electrostatic capacity is formed to make micro-current flow through the corresponding condenser. The touch position is detected by detecting the change of the micro-current, and then the corresponding operation is processed.

In the prior art, genders have also been developed and used which are configured to interconnect a portable terminal and an external device or to maintain a condition of being connected to a portable terminal in order to charge the portable terminal. A gender applied to a conventional portable phone as illustrated FIG. 14 and included in a previous patent application in the name of the present assignee will be described with reference to the drawing.

A gender 1 for a conventional portable terminal includes a male connector 4 configured to be insertion-coupled to a pin connector 3 provided in a portable terminal 2, and a gender body 8 provided with a female connector 7 configured to be connectable with an external connector 6 of a common charger or a data communication cable.

The gender body 8 is configured to be mechanically inserted into and fixed to the inside of a gender cap 10 to be capable of being removed by force, in which the gender cap 10 is connected to the portable terminal 2 via a string 9.

A touch pen for operating the touch screen of the portable terminal takes a form to be stored in a reception recess provided on the portable terminal or a case for protecting or receiving the portable terminal, or in a user's pocket when it is not used.

In the prior art as described above, when it is desired to interface the information of the portable terminal to an external device or the information of the external device to the portable terminal, a separate data cable or a charger should be used, and when it is desired to use an existing cable or an existing charger, a gender should be used, and when it is desired to use the portable terminal through the touch screen of the portable terminal, a touch pen should be used.

Like this, although a gender and a touch pen are essential instruments or accessories in order to operate or manipulate the portable terminal, users frequently do not carry the gender and the touch pen due to the inconvenience of carrying and keeping them. For this reason, it may be impossible to use the portable terminal because the portable terminal cannot be charged from the outside, and a malfunction or erroneous input may be caused by directly touching the touch screen of the portable terminal with fingers, which makes it inconvenient to use the portable terminal.

In addition, because the gender and the touch pen are not carried together with the portable terminal, there is high danger of losing them. Even if the gender and the touch pan are located at home or in an office, it may be difficult to locate them after a long period of time, which may consequently lead to the loss. As a result, various problems, such as inconvenience in use and economic burden, occur in that it is necessary to buy another gender and touch pen for the future use of the portable terminal by paying extra costs.

### SUMMARY OF THE INVENTION

Accordingly, the present invention has been made to solve the above-mentioned problems occurring in the prior art, and according to an aspect of the present invention, a touch pen is configured such that a user grasps the touch pen and easily touches a touch screen of a portable terminal with the touch pen, and a gender unit is configured such that the gender unit is freely accommodated in and withdrawn from the inside of the touch pen, and is capable of interfacing information from the portable terminal to an external device and vice versa, and charging the portable terminal. As a result, even in a state where a user's hands are covered, for example, by gloves, the user may easily operate the portable terminal using the touch pen, and the usefulness and convenience of use of the touch pen can be enhanced as the touch pen is provided together with the gender unit configured to conduct an interfacing between the portable terminal and an external device.

According to the present invention, because the touch pen is configured such that a gender unit can be integrally accommodated and stored in the touch pen, it is possible to solve the inconvenience and trouble caused by separately carrying the touch pen and the gender unit. Furthermore, even in a state in which the user wears gloves, for example, in the winter season, the user's convenience that allows the user to easily conduct input to a touch screen of a portable terminal using the touch pen can be improved.

Moreover, according to another aspect of the present invention, the touch pen may further include a portable storage device so that the touch pen can be used in place of a USB memory which is typically carried separately. As a result, the inventive touch pen has usefulness in that it can exhibit functional effects of three products, i.e. a gender, a touch pen, and a portable storage device, as a single product.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a first embodiment of the present invention in which a touch pen for a portable terminal having a gender unit, to which the inventive technology is applied, is illustrated;

FIG. 2 is a cross-sectional view of the first embodiment, in which the touch pen for a portable terminal having the gender unit, to which the present invention is applied, is illustrated;

FIG. 3 is a cross-sectional view of a modified embodiment of the first embodiment in which a different coupling structure of the touch pen for a portable terminal having the gender unit, to which the present invention is applied, is illustrated;

FIG. 4 is an exploded perspective view of another modified embodiment of the first embodiment, in which a different coupling structure of the touch pen for a portable terminal having the gender unit, to which the present invention is applied, is illustrated;

FIG. 5 is an exploded perspective view of a design modified embodiment of the first exemplary embodiment, in which the touch pen for a portable terminal having a gender unit, to which the present invention is applied, is illustrated;

FIG. 6 illustrates perspective views of modified embodiments to the first exemplary embodiment;

FIG. 7 is a perspective view of a second exemplary embodiment of the present invention, in which a touch pen for a portable terminal having a gender unit, to which the present invention is applied, is illustrated;

FIG. 8 is an exploded perspective view of the second exemplary embodiment, in which the touch pen for a portable terminal having the gender unit, to which the present invention is applied, is illustrated;

FIG. 9 is a cross-sectional view of the second exemplary embodiment, in which the touch pen for a portable terminal having the gender unit, to which the present invention is applied, is illustrated;

FIG. 10 is a perspective view of a modified embodiment of the second exemplary embodiment, in which a touch pen for a portable terminal having a gender unit, to which the present invention is applied, is illustrated;

FIG. 11 is a perspective view of another modified embodiment of the second exemplary embodiment, in which a touch pen for a portable terminal having a gender unit, to which the present invention is applied, is illustrated;

FIG. 12 is a perspective view of another modified embodiment of the first and second exemplary embodiments, in which a touch pen for a portable terminal having a gender unit, to which the present invention is applied, is illustrated;

FIG. 13 is a perspective view of another modified embodiment of the second exemplary embodiment, in which a touch pen for a portable terminal having a gender unit, to which the present invention is applied, is illustrated; and

FIG. 14 is a descriptive view illustrating a use of a conventional gender for a portable terminal.

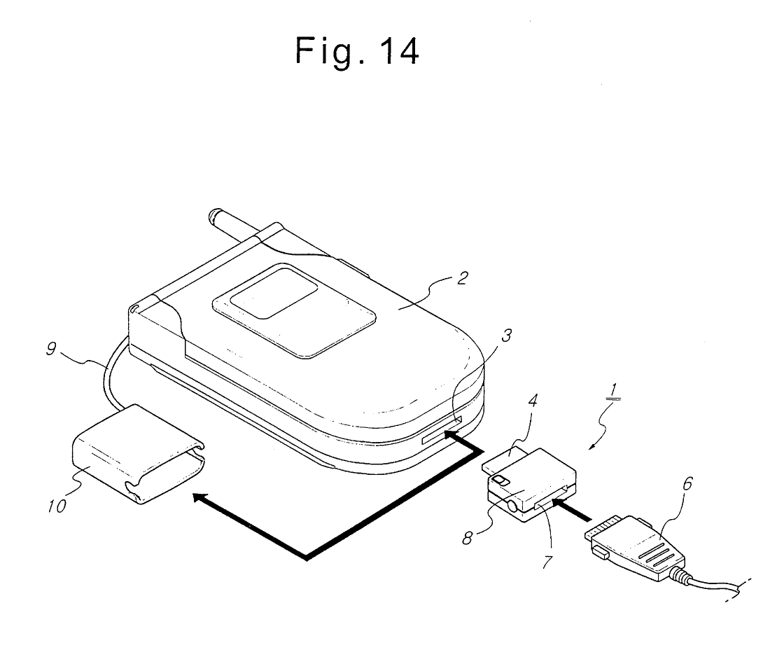

### DETAILED DESCRIPTION OF THE PREFERRED EMBODIMENTS

Hereinafter, the configurations and functional actions of preferred embodiments of the present invention will be described with reference to the accompanying drawings.

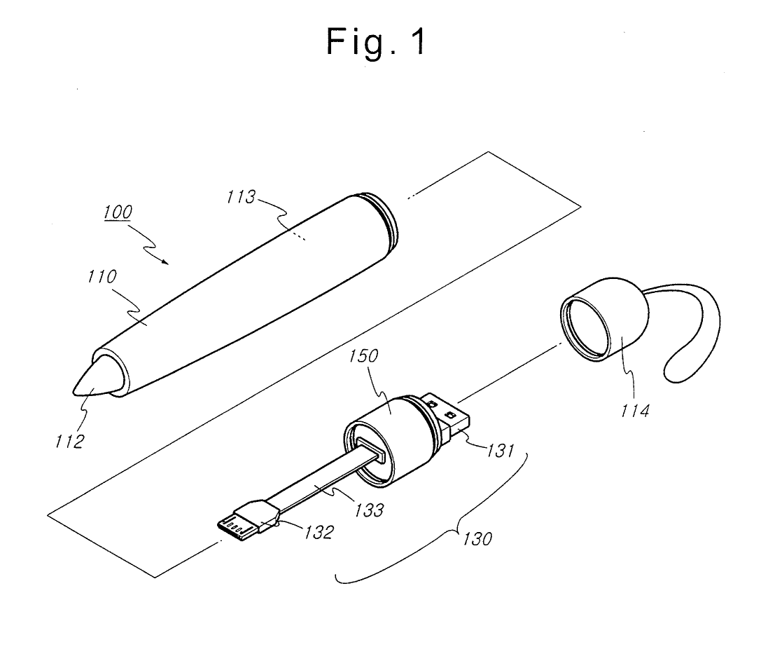

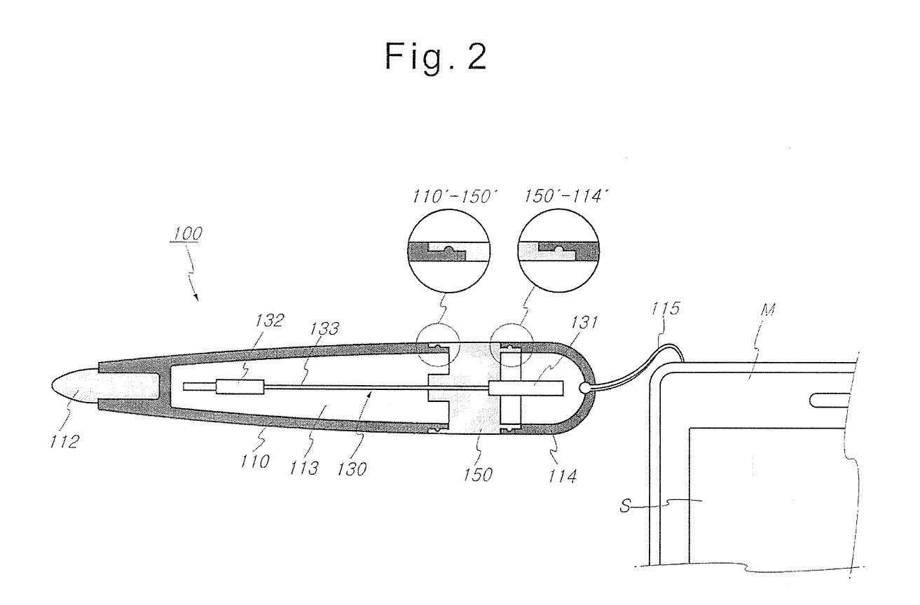

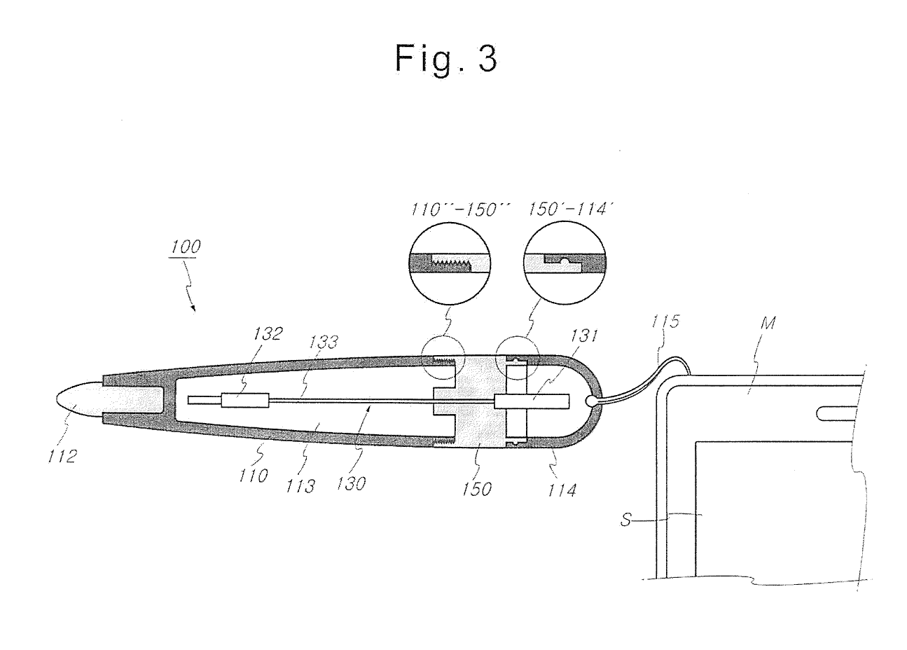

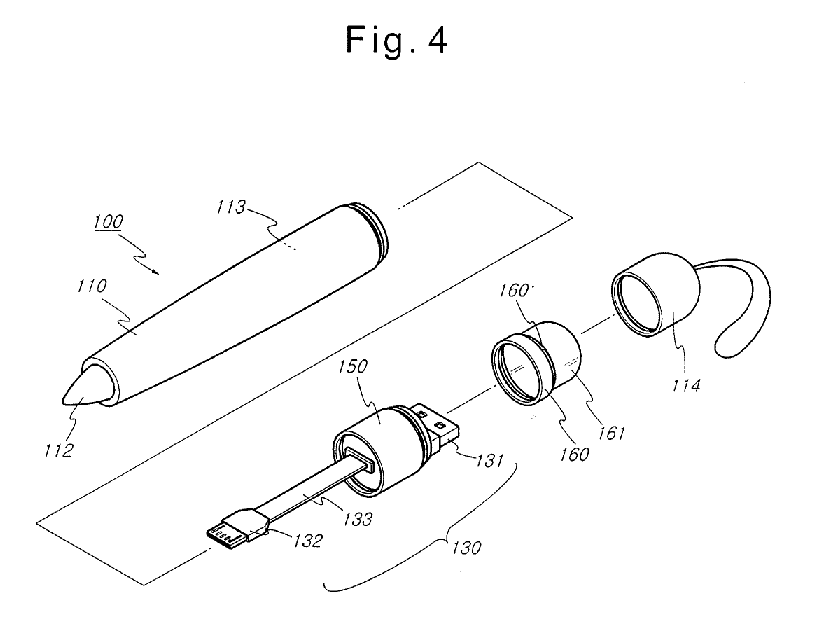

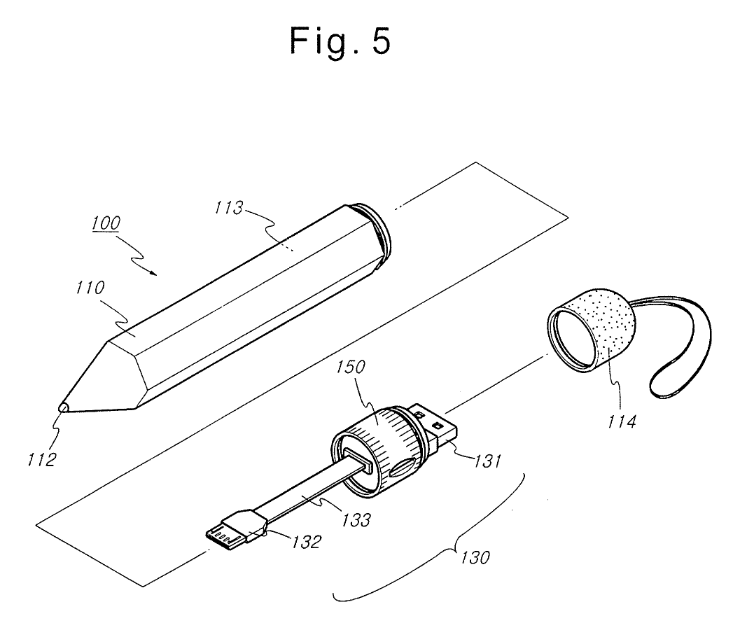

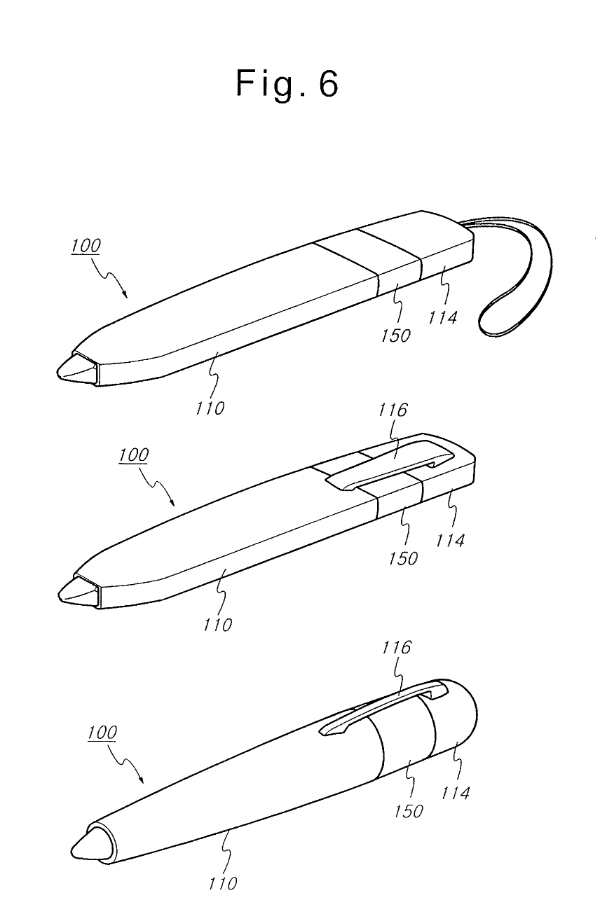

FIG. 1 is an exploded perspective view of a first embodiment of the present invention in which a touch pen for a portable terminal having a gender unit, to which the inventive technology is applied, is illustrated, FIG. 2 is a cross-sectional view of the first embodiment, and FIG. 3 is a cross-sectional view of a modified embodiment of the first embodiment in which a different coupling structure of the touch pen is illustrated. In addition, FIG. 4 is an exploded perspective view of another modified embodiment of the first embodiment, in which a different coupling structure of the touch pen, FIG. 5 is an exploded perspective view of a design modified embodiment of the first exemplary embodiment, and FIG. 6 illustrates perspective views of modified embodiments to the first exemplary embodiment. The first exemplary embodiment of the present invention will be described with these drawings.

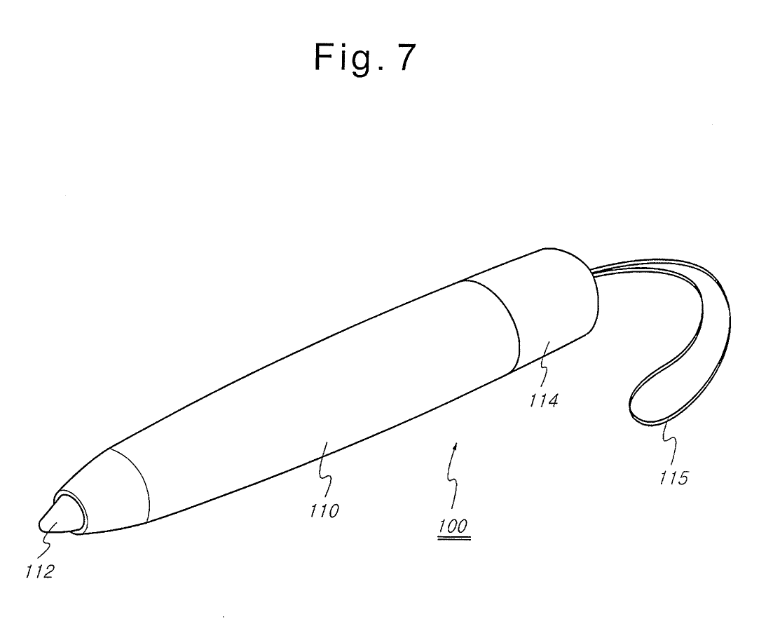

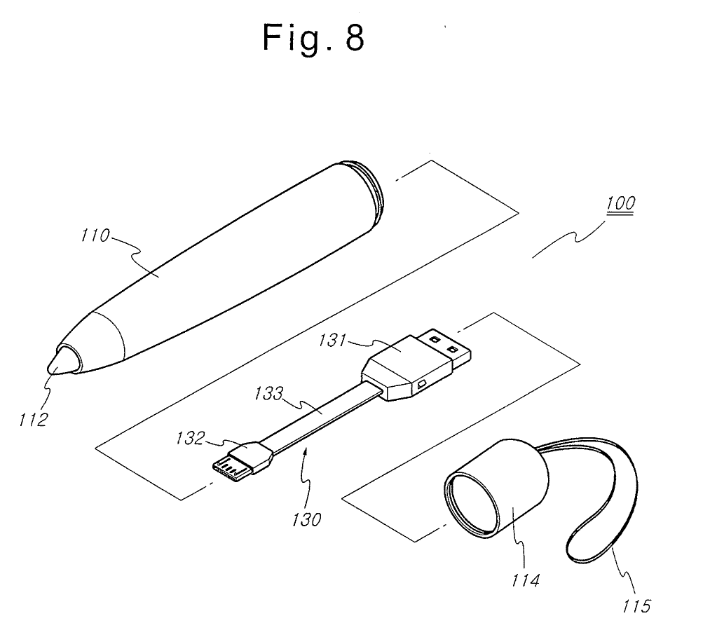

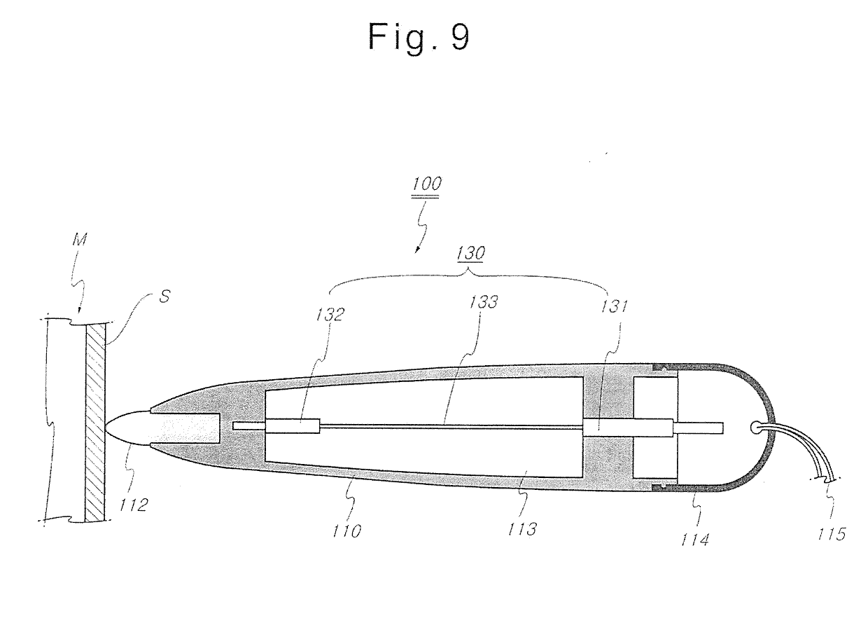

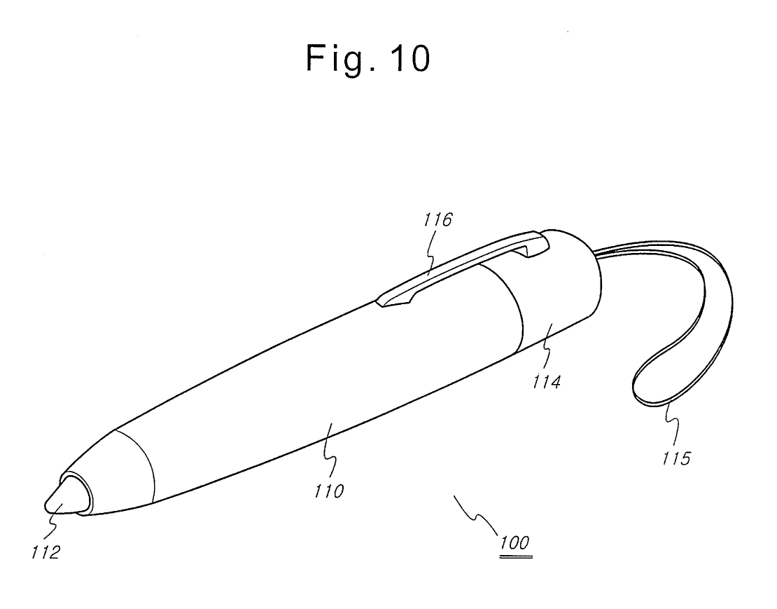

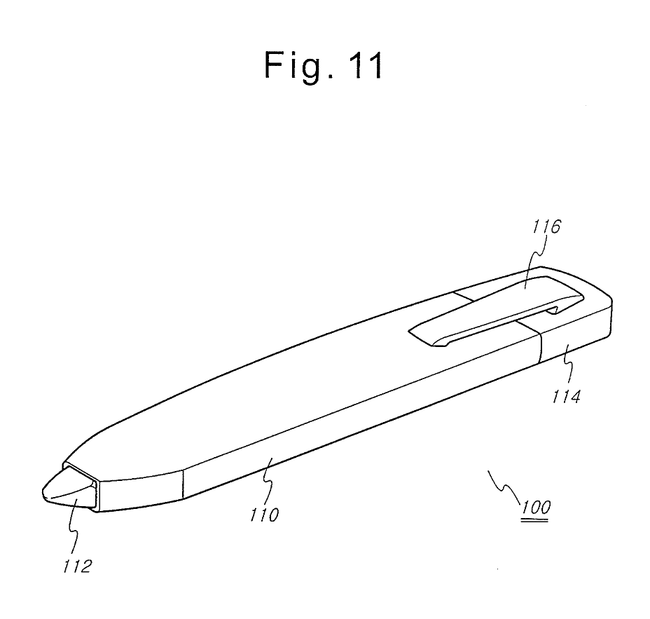

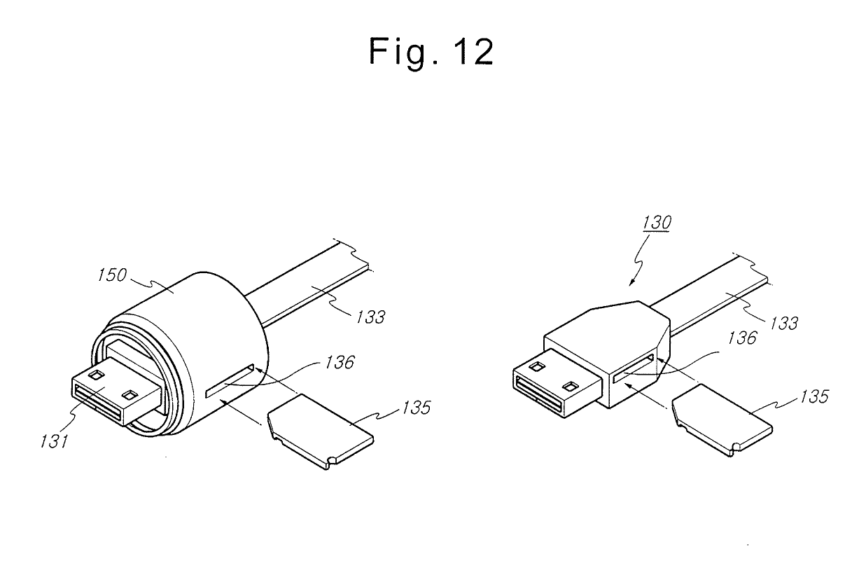

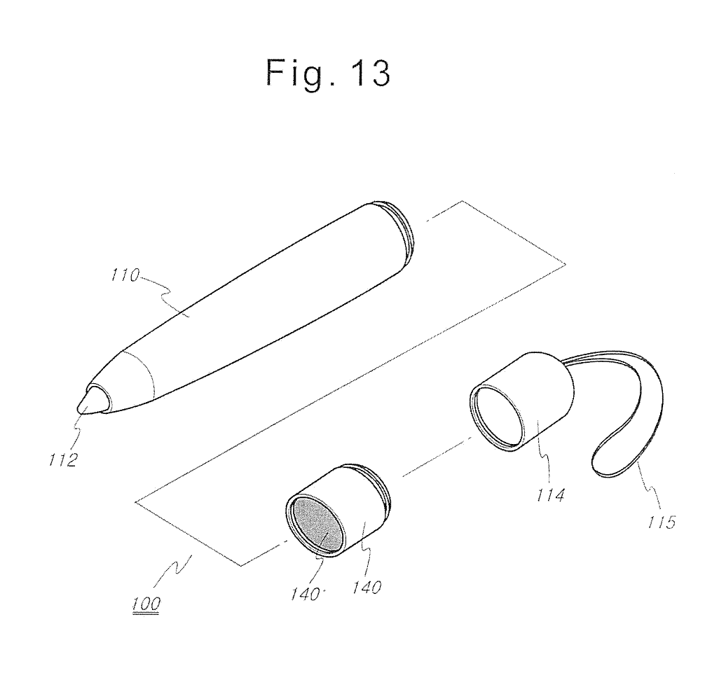

FIG. 7 is a perspective view of a second exemplary embodiment of the present invention, in which a touch pen for a portable terminal having a gender unit, to which the present invention is applied, is illustrated, FIG. 8 is an exploded perspective view of the second exemplary embodiment, and FIG. 9 is a cross-sectional view of the second exemplary embodiment. In addition, FIG. 10 is a perspective view of a modified embodiment of the second exemplary embodiment, FIG. 11 is a perspective view of another modified embodiment of the second exemplary embodiment, FIG. 12 is a perspective view of another modified embodiment of the first and second exemplary embodiments, and FIG. 13 is a perspective view of another modified embodiment of the second exemplary embodiment. The second exemplary embodiment will be described in sequence with reference to these drawings.

The same members in the first and second exemplary embodiments will be denoted by the same reference numerals.

### First Exemplary Embodiment

At first, a first exemplary embodiment of a touch pen 100 for a portable terminal, which has a gender unit, to which the inventive technical idea is applied, will be described with reference to FIGS. 1 to 6.

The touch pen 100 includes a pen body 110 having a shape which may be the same with or similar to a writing instrument or may take various shapes to be described below so that a user conveniently and easily grasps the touch pen 100 by hand and touches a touch screen of a portable terminal using the touch pen 100. The touch screen may take various types and shapes of touch screens not illustrated herein. A connector cap 150 is coupled with the pen body 110 by an engagement-coupling structure through a ring-shaped rib and indentation groove 110′-150′ as illustrated in FIG. 2, or through a screw-coupling structure (not shown).

In addition, at the rear end of the connector cap 150, a cover cap 114 is provided to be coupled to the connector cap 150 by a male and female coupling through another ring-shaped rib and indentation groove 150′-114′ to be engaged with and fixed to each other, in which a string 115 for connection to a portable terminal M is connected to the cover cap 114. In other words, the pen body 10, the connector cap 150, and the cover cap 114 are inter-engaged with or screw-coupled with each other, thereby forming the entire body of the touch pen 100.

The pen body 110 is provided with a sensitive touch tip 112 at the tip end thereof, in which the sensitive touch tip 112 is well-known in the art and serves as a means for applying an operation signal by touching the touch screen S of the portable terminal M.

The inside of the pen body 110 is formed with a unit accommodating space 113 for accommodating a gender unit 130 as a hollow space. In other words, the gender unit 130 configured as described later will be accommodated in the internal space of the pen body 110.

The sensitive touch tip 112 may be differently configured according to the type of the touch screen of the portable terminal. For example, if the touch screen is a pressure sensitive type touch screen, the sensitive touch tip 112 is configured as a pressure sensitive touch tip, and if the touch screen is a conductive touch screen, the touch screen may be configured as a conductive sensitive touch tip. The sensitive touch tip may be configured to be selectively removable.

The sensitive touch tip 112 may be formed from various materials, for example, an acryl, a polyester, a rubber, a plastic, a polymer. For the conductive sensitive touch tip, it is only needed to provide conductivity to these materials.

A separate sensitive touch tip cap (not shown) may be provided so as to protect the sensitive touch tip 112. If the sensitive touch tip 112 is a conductive sensitive tip, it is natural that an electric arrangement required for operating the sensitive tip is provided in the inside of the pen body 110. Because such an electric arrangement is well-known in the art, a detailed description thereof will be omitted.

As illustrated in FIGS. 1 and 2, the gender unit 130 provided in pen body 110 is provided with a first connector 131, for example, a USB port connector, to be connected with another external connection device, for example a personal PC for data transmission, or a charger for charging, at the rear end portion (the cover cap 114 side end portion) of the pen body 110. The first connector 131 is fixedly accommodated in an embedded form through an insert injection molding or by fixedly inserting the first connector 131 into a channel extending through the center of the cover cap 140. A cable 133 connected to the first connector 131 and extending forward is connected with another connector, for example, a second connector 132, such as a micro USB. Through this, the entire gender unit 130 is configured.

Of course, considering the practical usefulness, it is desirable that the cable 133 is flexible.

In general, the first and second connectors 131 and 132 may be selected from various combinations of a 7-pin type connector, a 12-pin type connector, a 20-pin type connector, a 24-pin type connector, a USB, and a micro USB which are widely used. A combination of a standard USB and a micro USB is most preferable because such a combination is recently applied to smart phones as a standard.

In depicting the first connector 131 as the USB connector in the drawings, especially in FIG. 1, it is illustrated that a usual metal housing is installed to complete the USB connector body for stable fixing when inserting the first connector 131, which is a male connector, into a female connector of a typical USB connector. However, as a modified embodiment, if the first connector 131 is formed as a flat connector from which the metal housing is removed (not shown), the entire diameter of the touch pen 100 may be further reduced, so that the touch 100 may be manufactured in a thickness that is close to a thickness of an ordinary pen.

In order that various kinds of memory cards 135 may be used in one of the first and second connectors 131 and 132 rather than directly conducing interfacing from the portable terminal to an external device or from the external device to the portable terminal, a card slot 136 capable of accommodating a memory card 135 may be additionally formed in the connector cap 150 or a portion protruding from the connector cap 150 of the first connector 131 as illustrated in FIG. 12. In such a case, the inventive touch pen may be used as a mobile disc storage. Because the electric wiring in this case is conventional, it will not be additionally described.

With this function, the inventive touch pen provides a convenience in that it may be used in place of a USB memory which has been separately carried. In other words, the inventive touch pen is useful in that it can function as three products, i.e. a gender, a touch pen, and a storage device, within a single portable product.

The card slot 136 may be provided at any position, for example a side portion or a front portion of each of the first and second connectors 131 and 132 unless the position affects an interconnection between the portable terminal and an external device.

For the coupling structure of the pen body 110, the connector cap 150 and the cover cap 114, the ring-shaped rib and indentation groove engagements 110′-150′ and 150′-114′ as illustrated in FIG. 2 or screw couplings not illustrated in the drawings may be employed in a selective combination. However, as illustrated in FIG. 3, it is most preferable that the coupling between the pen body 110 and the connector cap 150 is implemented by a screw-coupling 110″-150″ and the coupling between the connector cap 150 and the cover cap 114 is implemented by a rib and indentation groove engagement 150′-114′.

This is because as the use as a touch pen is frequent and should be instantly performed, the insertion engagement method that allows the assembly of the pen body 110 and the connector cap 150 to be instantly removed from the cover pen 114 is preferable, as the use as the gender unit 130 is not frequent and does not require an instant reaction, the screw-coupling may prevent the loss of the gender unit 130 due to the unintended and unexpected breaking-off of the gender unit 130, and when used as a stylus pen, as the user pulls the pen body 110 and the connector cap 150 from the cover cap 114, the pen body 110 and the connector cap 150 can be readily removed from the cover cap 140 in unison, and the user can directly access the input mode.

As another modified embodiment, as illustrated in FIG. 4, a protective cap 160 may be additionally provided as an inner cap accommodated in an additive cap or the cover cap 140 between the connector cap 150 and the cover cap 140 in the combination of the pen body 110, the connector cap 150, and the cover cap 140.

In such a case, the protective cap 160 may be screw-coupled with the pen body 110, and may be coupled with the cover cap 114 in such a manner by forming a rib 160′ on the protective cap 160 and making the rib 160 be fixedly engaged in the indentation groove 114′ of the cover cap 114. In this manner, the above-mentioned functions can be obtained.

When configured as an inner cap, the protective cap 160 may take a dual cap structure in which an upper connector accommodation end 161 is accommodated in the cover cap 114. Although the protective cap 160 may be additionally provided to prevent the infiltration of foreign matter into an exposed insertion part of the first connector 131, such as a USB connector, and to remove the user's repulsion felt by the protrusion of a mechanical element, the protective cap 160 is not necessarily needed. Preferably, the protective cap 160 may be formed from a semi-transparent material so that the user can recognize that an additional element exists in the inside of the protective cap 160.

Now, the use of a touch pen for a portable terminal having the inventive gender unit as configured above will be described.

When it is desired to use the touch pen 100 connected to the portable terminal M by the string 115 to be carried with the portable terminal, it is possible to conduct input to the touch screen S of the portable terminal M by removing the assembly of the pen body 110 and the connector cap 150 from the cover cap 114. After use, the assembly of the pen body 110 and the connector cap 150 may be fixedly inserted into the cover cap 114 again. As such, the touch pen 100 is turned to the carrying mode.

When it is desired to use the touch pen as a gender or a portable storage device, it is possible to disassemble the assembly of the pen body 110 and the connector cap 150 and to only grasp and connect the connector cap 150 having the gender unit 130 to a personal PC, a charger or the like. After use, the cap 150 may be fixedly assembled again.

As illustrated in FIGS. 1 and 2, a touch pen for a portable terminal having the inventive gender unit may be variously designed and developed to cater to consumers' diversified tastes, for example, as a fancy product, beyond as a simple pen shape.

For example, as the illustrative design of FIG. 5, the pen body 110 may be formed in a shape of a stubby pencil, the connector cap 150 may be formed in a shape of a ring member grasping an eraser rubber, and the cover cap 114 may be formed in a shape of an eraser. By designing in this manner, the touch pen may cater to youngsters' tastes. In addition, by providing an analogous design of the pencil shape to a digital device, the touch pen may function as an ornamental accessory.

Of course, a lot of designs which are based on various elongated bar shape bodies, for example, a colored pencil and an injector may be applied as described above.

A touch pen for a portable terminal having the inventive gender unit may be provided with other additive configurations in order to improve portability and to prevent loss. Of course, the touch pen may be modified to have various shapes, for example, a flat shape as illustrated at the top portion of FIG. 6 which is easy to carry together with the portable terminal M, and a shape to which a clip 116 is attached as illustrated at the middle and bottom portions of FIG. 6 which is adapted to be fixed to a pocket or the like by the clip 116, and all the modified shapes are very important in view of portability and aesthetic sense.

### Second Exemplary Embodiment

A second exemplary embodiment and several modified embodiments to the second embodiment are illustrated in FIG. 7 to FIG. 13.

Referring to FIG. 7, a touch pen 100 also includes a hollow pen body 110 having a shape which may be the same with or similar to a writing instrument or may take various shapes to be described below so that a user conveniently and easily grasps the touch pen 100 by hand and touches a touch screen for a portable terminal which may take various types and shapes of touch screens not illustrated herein. A gender unit 130 is provided in the inside of the pen body 110 to be freely received in or withdrawn from the inside of the pen body 110, so that an interfacing of information from the portable terminal to an external device or vice versa or a charging of the portable terminal can be easily executed.

The pin body 110 has a length which is relatively long as compared to the width thereof, and is equipped with a sensitive touch tip 112 at the lower end of the pin body 110. The sensitive touch tip 112 is well-known in the art and is configured to be contacted with a touch screen of a portable terminal.

In the inside of the pen body 110, a unit accommodation space 113 is formed that accommodates the gender unit 130, and at the top end of the pen body 110, a removable cover cap 114 is joined to prevent the exposure of the gender unit 130, thereby removing the concern of loss.

In order to prevent the cover cap 114 from easily breaking out, breaking-out prevention means, for example, a male-female engagement configuration or a screw-coupling configuration as in the first exemplary embodiment may be provided on the pen body 110 and the cover cap 114, and the cover cap 114 is also provided with a string 115 to be connected with a portable terminal.

In the second exemplary embodiment, the pen body 110 takes a cylindrical shape like a conventional writing instrument. However, the pen body 110 may be configured in various shapes. For example, the pen body 110 may be formed in a flat shape in cross-section as illustrated in FIG. 11, thereby improving the design of an external appearance thereof while reducing the volume thereof.

Although the cover cap 114 is provided with the string 115 to be connected and used with a portable terminal, the cover cap 114 may be provided with a clip 116 as in the modified embodiment of FIG. 10, so that the touch pen may be separated from the portable terminal and carried in the state where it is clipped to the user's pocket.

Also in the present exemplary embodiment, a card slot 136 capable of accommodating a memory card 135 may be in any one of the first and second connectors 131 and 132 such that various types of memory cards 135 may be used rather than directly performing interfacing information from the portable terminal to an external device or from the external device to the portable terminal, as illustrated in FIG. 12.

Also, the card slot 136 may be provided at any position, for example a side portion or a front portion of each of the first and second connectors 131 and 132 unless the position affects an interconnection between the portable terminal and an external device.

As another modified embodiment of the present invention, the touch pen 100 may further include an auxiliary cap 140 having a partition wall 140′ as illustrated in FIG. 13, in order that, when the pen body 110 is separated from the cover cap 114 connected with the portable terminal through the string 115 to be used as a touch pen, the auxiliary cap 140 is used as a cap to remove the concern of breaking-out of the gender unit 130 installed within the pen body 110 and to prevent the gender unit 130 from being visually exposed.

Now, the use of the touch pen 100 for a portable terminal having the inventive gender unit as described above will be described.

The touch pen 100 for a portable terminal having the inventive gender unit may be carried together with the portable terminal as an accessory form by being connected with the portable terminal using the string 115 or may be received in a user's pocket using the clip 116 provided on the cover cap 114 in the state where the touch pen 100 is separated from the portable terminal.

In this received state, the user may separate the pen body 110 from the cover cap 114 connected to the portable terminal through the string 115, or may release the clip 116 from the pocket, then grasp the pen body 110 in a type of grasping a writing instrument, and then conduct input by touching the touch screen of the portable terminal by the sensitive touch tip 112 provided at the lower end of the pen body 110.

Of course, according to the type of the touch screen, the user may replace the sensitive touch tip 112 with a pressure sensitive touch tip or a conductive sensitive touch tip to be capable of manipulating or operating the portable terminal by touching the touch screen of the portable terminal.

When manipulating or operating the portable terminal by touching the touch screen of the portable terminal using the pen body 110 as described above, there is an advantage in that the portable terminal can be easily manipulated or operated in a situation where the manipulation or operation should be performed in a state where the user's hands are covered with gloves in a cold season, such as the winter season, or due to the nature of manipulation or operation.

In addition, when it is desired to charge the portable terminal or to conduct interfacing information from the portable terminal to an external device or from the external device to the portable terminal using the gender unit 130, the user may remove the cover cap 114 or the auxiliary cap 140 coupled to the top end of the pen body 110, and then grasp and pull out the gender unit 130 exposed from the unit accommodation space 113 in such a manner that the gender unit 130 accommodated in the unit accommodation space 113 of the pen body 110 may be withdrawn.

The touch pen 100 becomes usable by connecting the first and second connectors 131 and 132 of the gender unit 130 withdrawn as described above with a connector slot of the portable terminal or the external device. When it is required to use the memory card 135, the touch pen may be used as a portable storage means by inserting the memory card 135 into the card slot 136 provided in any of the first and second connectors 131 and 132.

Although not separately illustrated in the drawings, the touch pen may also be configured merely as a unit accommodation body, i.e. an accommodation case to accommodate the gender unit that executes the interfacing, charging and data exchange/transmission functions as described above without being provided with the sensitive touch tip to maximize the portability.

The inventive touch pen has advantages in that even in a state where gloves are worn on the user's hands, the user is allowed to easily operate the portable terminal using the touch pen, and because the gender unit for interfacing between the portable terminal and an external device may be provided together with the touch pen, the utilization and convenience of use of the touch pen can be improved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A touch pen (100) configured to touch a touch screen of a portable terminal, comprising:
a hollow pen body (110);
a connector cap (150), of which one end is coupled to an end of the pen body (110);
a cover cap (114) coupled to the other end of the connector cap (150); and
a gender unit (130) including a first connector (131) at one end and a second connector (132) at the other end,
wherein the first connector (131) protrudes to the cover cap 114 side, and is fixedly accommodated by being embedded in the connector cap (150),
wherein the second connector (132) is connected to a flexible cable (133) extending from the connector cap (150) and accommodated in the pen body (110), and
wherein the first connector (131) of the gender unit (130) forms a standard USB, and the second connector (132) connected with the flexible cable (133) at the other end of the gender unit (130) forms a micro USB.

2. A touch pen (100) configured to touch a touch screen of a portable terminal according to claim 1, wherein the first connector (131) is the connector of standard USB and the second connector (132) is the connector of micro USB connector or 8 pin lighting connector for iOS.

3. A touch pen (100) configured to touch a touch screen of a portable terminal, comprising:
a pen body 110;
a sensitive touch tip (112) provided at a lower end of the pen body to be contacted with the touch screen of the portable terminal; and
a gender unit (130) provided with a first connector (131) at one end, and a second connector (132) at the other end,
wherein the pen body (110) has a relatively long length as compared to the width thereof,
wherein an open/close type cover cap (114) is coupled to the top end of the pen body and a unit accommodation space (113) is formed in the inside of the pen body (110), and
wherein the gender unit (130) is accommodated in the unit accommodation space (113), the first connector (131) of the gender unit (130) forming a standard USB, and the second connector (132) connected with the flexible cable (133) at the other end of the gender unit (130) forming a micro USB.

4. A touch pen (100) configured to touch a touch screen of a portable terminal according to claim 2, wherein the first connector (131) is the connector of standard USB and the second connector (132) is the connector of micro USB connector or 8 pin lighting connector for iOS.
